(19) United States
(12) Patent Application Publication
(10) Pub. No.: US 2026/0251803 A1
(43) Pub. Date: Aug. 27, 2026

(54) METHOD FOR DETERMINING THE POSITION OF A DEVICE BASED ON A NETWORK OF SATELLITES IN A PREDICTIVE SYSTEM

(71) Applicant: TORUS ACTIONS, TOULOUSE (FR)

(72) Inventors: Hong Son HOANG, VILLENEUVE TOLOSANE (FR); Tien Dung NGUYEN, TOULOUSE (FR); Matthieu OLIVIE, LABEGE (FR); Remy BARAILLE, COUFFOULEUX (FR); Frederic PROTIN, TOULOUSE (FR)

(73) Assignee: TORUS ACTIONS, TOULOUSE (FR)

(21) Appl. No.: 18/879,305

(22) PCT Filed: Jun. 28, 2023
(86) PCT No.: PCT/EP2023/067730

§ 371 Date: Dec. 27, 2024

(30) Foreign Application Priority Data
Jun. 29, 2022 (FR) FR2206514

(51) Int. Cl. G01S 19/39; G01S 19/37

(52) U.S. Cl. CPC G01S 19/393; G01S 19/37

(57) ABSTRACT

The invention relates to a method for measuring the position of a device based on a network of satellites in a predictive system comprising a filter with a variable gain K, said gain K being represented by a vector of variable gain coefficients, said method, which is implemented by the device, comprising, in particular in each iteration following a time t, the steps of minimizing the expectation of the square of the innovation of the filter at the time t+I, the innovation being computed based on the coefficients of the gain, in order to improve the accuracy of the positioning.

### TECHNICAL FIELD

The present invention relates to the field of satellite positioning and more particularly concerns a geolocation method and device.

### BACKGROUND

Over the years, the positioning and navigation techniques have been revolutionised by Global Navigation Satellite Systems (GNSS). Today, the satellite positioning and navigation are important tools for security, including maritime safety, ballistic guidance systems and vehicle and personnel tracking. In particular, various phases of flight, vessel traffic, en-route, approach or landing are achieved by satellite positioning, since global satellite navigation systems have planetary coverage and do not require ground-based navigation aids, allowing an optimal route planning, an improved air and ocean space and reduced operational costs.

The main concern in the applications using the satellite positioning is reliability and continuity. The satellite positioning algorithms are now designed and evaluated using an important performance metric called integrity to prevent malfunctions and ensure reliability—a measure of the confidence placed in a system. This is achieved by issuing alerts when it is unsafe to use the satellite positioning system.

In these global satellite navigation systems, the satellites transmit signals that allow the receivers to calculate their position. These signals are obtained by phase modulating a carrier with coded messages and are available on several frequencies. The receiver, for example in a smartphone or a positioning system, embedded in a vehicle, comprises a low-cost chip that allows the reception of a single frequency and provides the positioning based on the code measurements only, without including a correction measurement algorithm.

This positioning method allows to a control accuracy of the order of five metres in the open areas. By including a measurement correction algorithm based, for example, on a Kalman filter, it is possible to obtain an accuracy of the order of a metre. However, this accuracy is insufficient for certain applications that require centimetre-level precision, such as the autonomous and semi-autonomous vehicles, whatever the environment (motorway, urban, etc.) wherein they operate.

Obtaining a centimetre accuracy in the geolocation is complicated when the signal is disturbed, particularly in urban environments with obstacles that may block or reflect the signals from the satellites. This accuracy, already obtained in an open environment through the use of a merging filter, may be obtained in urban areas by combining the measurements obtained using satellite signals with data from several sensors and with an appropriate choice of filter associated with a dynamic model. However, such multi-sensor systems are complex and expensive.

In this context, it is essential to design the best possible filtering algorithm for the GNSS positioning of the vehicle.

To date, the Extended Kalman Filter-based satellite positioning algorithm is recognised as the most powerful and widely used tool for processing satellite signals to provide a reliable position estimation. The reason for this is that the Kalman filter is recursive over time and takes into account the contribution of all the measurements in an optimal way, processing only the current measurements without needing to store all the past data. In particular, for the linear input-output systems, the Kalman filter is the best linear estimator in the sense of the minimum average square error (MMSE) provided that the process and measurement covariances are known exactly.

The difficulty of obtaining accurate statistics is a major and practically insurmountable obstacle to guaranteeing an accurate positioning of the vehicle by the Kalman filter. There are many attempts to overcome this difficulty and most of them are based on the online estimation of the covariance matrices to improve the performance of the Kalman filter, which is then said to be “adaptive” (AKF).

There is therefore a need for a solution that at least partially remedies these disadvantages.

### SUMMARY

One of the aims of the invention is to offer a simple, effective and accurate geolocation solution. Another aim of the invention is to offer an alternative filter solution adapted to the geolocation. Another aim of the invention is to provide a technical solution that allows to improve the geolocation accuracy compared with a solution using a Kalman filter, particularly in the presence of obstacles that make the processing non-linear. Another aim of the invention is to provide a solution for early detection of the degradation in the quality of the geolocation signals.

To this end, the invention firstly has as its object a method for measuring the geographical position of a device based on a network of satellites in a forecasting (i.e. predictive) system with a filter of variable gain, said gain being represented by a vector of variable gain coefficients, said method, implemented by the device, comprising, for an iteration at a time t+1, the steps of:
receiving signals transmitted by a plurality of satellites in the satellite network,
determining the position and/or the speed of the device at a time (t+1) from the signals received, referred to as “observation at time (t+1)”,
calculating the best prediction of the state of the system at time (t+1) on the basis of a predetermined estimation of the state of the system at time t and a model representing the system between time t and time (t+1),
calculating the prediction of the observation at time (t+1) as the product of a predetermined observation matrix and the best prediction of the state of the system at time (t+1) calculated,
calculating the innovation of the filter at time (t+1) as the difference between the observation at time (t+1) and the prediction of the observation at time (t+1),
determining the vector of gain coefficients at time (t+1) by minimising the square of the norm of the innovation of the filter at time (t+1) calculated in the previous step,
calculating the gain at time (t+1) by making a correction by stochastic approximation using time averaging of the gain coefficients of the vector of gain coefficients determined,
calculating the estimation of the state of the system at time (t+1) as being the sum of the best prediction of the state of the system at time (t+1) calculated and the product of the gain at time (t+1) and the innovation of the filter at time (t+1) calculated,
determining the position of the device from the estimation of the state of the system at time (t+1) calculated.

The method according to the invention allows a high geolocation accuracy thanks to the use of a stable adaptive filter. Minimising the expectation of the square of the filter innovation at time t+1 calculated from the gain parameters corresponds to minimising the mathematical expectation of the square of the distance between the observation at time t and its calculated prediction, which makes the calculations simple and therefore requires less computing power than for a Kalman filter. The vector of gain coefficients is a vector of parameters to be defined at each step (control parameters) in the gain of the filter. Under an ergodicity condition, minimising the mathematical expectation of the square of the norm of the filter innovation in the probability space is equivalent to minimising the time average of the square of the norm of the filter innovation. This allows us to derive the recurrence equation for calculating the control parameters in the gain. Thus, advantageously, the original minimisation problem may be replaced by time-averaged minimisation, which is not the case in a Kalman filter. The method according to the invention does not require the specification of input statistics for random variables (in particular, model error, observation error, etc.). As the filtering process progresses, the method according to the invention approaches the optimal operation. In addition, the averaging of the gain over time allows to provide a smoothing effect which stabilises the filter and therefore reduces the error. The Kalman filter is theoretically optimal only when the statistics of the measurement and model errors are known with exact accuracy and when, in addition, the model is linear, which is rarely the case in practice. The method according to the invention is not constrained by this restriction, and the use of the AF allows a very accurate geolocation, particularly in the presence of obstacles around the device, which would cause the error statistics to be lost and render the Kalman filtering non-linear. In practice, the majority of the dynamic and observation systems are non-linear. The Kalman filter is only optimal for the linear filtering problems. The Extended Kalman Filter (EKF), an extension of the KF for the non-linear systems, is not optimal. Due to the iterative temporal minimisation of the mathematical expectation of the square of the norm of the innovation, the method according to the invention does not require linearization for the non-linear systems, and retains an optimality of the non-linear filters. For large model and observation errors, the large differences between the introduced statistics and the actual statistics lead to a worse gain specification in the Kalman filter. As a result, the estimation errors, and even the discrepancies, may become significant with a Kalman filter. The method according to the invention learns the uncertainties of the model and the observation error statistics from filter innovation realisations and is able to keep the estimation errors to a low level, which is synonymous with robustness. The filter used in the method according to the invention is stable, in particular because it is not constrained by the solution of the Riccati equations for the error covariance matrices, as is the case with a Kalman filter. The method described in this invention is a simple and effective method for the satellite positioning, with a low level of knowledge of noise statistics. In particular, the method described in the invention allows a more accurate estimation in the context of the satellite positioning, with a limited computing load and storage requirement.

Advantageously, one variant is to use, as the observation vector, not the speeds and the positions, but the list of pseudoranges associated with each satellite visible to the receiver, i.e., for each of these satellites, the speed of the light in vacuum multiplied by the delay between the transmission and the reception.

Preferably, the method further comprises, at each iteration, a step of bounding the variable gain coefficients between a minimum and a maximum in order to improve the smoothing while being simpler than an obvious solution using a Hessian.

Even more preferably, the gain coefficients are bounded between a minimum value equal to a bounding variable ε (small and positive) and a maximum value equal to (2−ε).

In one embodiment, the calculations, in particular of the gain coefficients, are carried out by a neural network on the basis of a predetermined sample.

Advantageously, the model describing the system is devoid of the “acceleration” parameter, which is considered as a forcing, i.e. it is processed mathematically. This allows to optimise the size of the model, thereby reducing the number of processes and hence errors, thereby increasing the accuracy of the predictions and hence the localisation.

The invention also relates to a computer program product characterised in that it comprises an assembly of program code instructions which, when executed by one or more processors, configure the processor or processors to implement a method as hereinbefore set forth.

The invention also relates to a measurement module for measuring the geographical position of a device based on a network of satellites in a predictive system with a filter of variable gain, said gain being represented by a vector of variable parameters, said measurement module, embedded in said device, being configured for:
receiving signals transmitted by a plurality of satellites in the satellite network,
determining the position and/or the speed of the device at a time (t+1) from the signals received, referred to as “observation at time (t+1)”,
calculating the best prediction of the state of the system at time (t+1) on the basis of a predetermined estimation of the state of the system at time (t) and a model representing the system between time (t) and time (t+1),
calculating the prediction of the observation at time (t+1) as the product of a predetermined observation matrix and the best prediction of the state of the system at time (t+1) calculated,
calculating the filter innovation at time (t+1) as the difference between the observation at time (t+1) and the prediction of the observation at time (t+1),
determining the vector of gain coefficients at time (t+1) by minimising the square of the norm of the filter innovation at time (t+1) calculated,
calculating the gain at time (t+1) by correcting by stochastic approximation using time averaging of the gain coefficients of the vector of gain coefficients determined,
calculating the estimation of the state of the system at time (t+1) as the sum of the best prediction of the state of the system at time (t+1) calculated and the product of the gain (K) at time (t+1) by the filter innovation at time (t+1) calculated,
determining the position of the device from the estimation of the state of the system at time (t+1) calculated.

Preferably, the measurement module is configured to bound the variable gain coefficients between a minimum and a maximum.

Preferably, the measurement module is configured to bound between a minimum equal to a bounding variable ε and a maximum equal to a bounding variable (2−ε).

Advantageously, the measurement module comprises a neural network configured to carry out the calculations by being optimised on the basis of a predetermined sample.

Advantageously, the measurement module is configured to store and use a model, representative of the system, without the “acceleration” parameter.

The invention also relates to a device, in particular a mobile device, comprising a measurement module as described above.

The invention also relates to a satellite-based geolocation system, said system comprising a plurality of satellites, each configured to transmit geolocation signals, and at least one measurement module as previously presented and/or at least one device as previously presented.

### BRIEF DESCRIPTION OF THE DRAWINGS

Other characteristics and advantages of the invention will become apparent from the following description. This is purely illustrative and should be read in conjunction with the attached drawings wherein:

FIG. 1 illustrates schematically one embodiment of the system according to the invention.

FIG. 2 schematically illustrates one embodiment of the method according to the invention.

FIG. 3 illustrates a first example of comparison between the Kalman filter and the method according to the invention with the same input data.

FIG. 4 illustrates an example of a vehicle trajectory error using a Kalman filter (prior art).

FIG. 5 illustrates an example of a vehicle trajectory error using the method according to the invention.

FIG. 6 illustrates an example of time-averaged absolute error for a vehicle trajectory with a Kalman filter of the prior art and with the method according to the invention.

FIG. 7 illustrates an example of absolute error along the axis X for the trajectory of [FIG. 6] with a Kalman filter of the prior art and with the method according to the invention.

FIG. 8 illustrates an example of absolute error along the axis Y for the trajectory of [FIG. 6] with a Kalman filter of the prior art and with the method according to the invention.

FIG. 9 illustrates an example of absolute error along the axis Z for the trajectory of [FIG. 6] with a Kalman filter of the prior art and with the method according to the invention.

### DETAILED DESCRIPTION

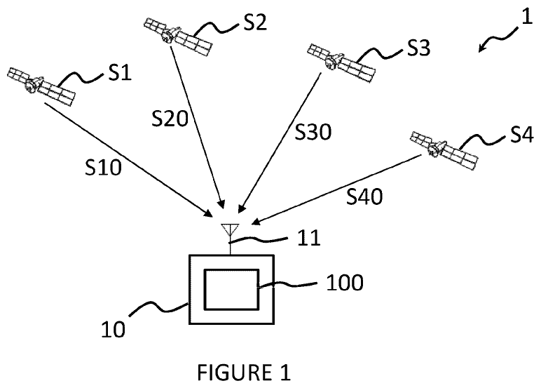

An example of a satellite-based geolocation system 1 is shown in [FIG. 1].

The system 1 comprises a constellation of satellites S1, S2, S3, S4 and a device 10 according to the invention. In [FIG. 1], only four satellites S1, S2, S3, S4 have been shown for the sake of clarity, but it goes without saying that the system 1 may comprise more than four satellites S1, S2, S3, S4, in particular dozens of satellites to be able to geolocate a device 10 in most, if not all, regions of the globe.

Each satellite S1, S2, S3, S4 is configured to transmit geolocation signals S10, S20, S30, S40.

The device 10, for example a smartphone or a vehicle, comprises a measurement module 100 configured to measure the position of said device 10 on the basis of signals S10, S20, S30, S40 emitted by the satellites S1, S2, S3, S4.

The measurement module 100, embedded in the device 10, is configured to receive signals S10, S20, S30, S40 transmitted by a plurality of satellites S1, S2, S3, S4 of the assembly of satellites S1, S2, S3, S4.

The measurement module 100 is configured to determine the position and/or the speed of the device 10 at a time (t+1) from the signals S10, S20, S30, S40 received, referred to as “observation at time (t+1)”. The position and/or the speed may be measured directly or from other prior measurements, such as “pseudoranges”, which are known per se.

The measurement module 100 is configured to determine the position p(t+1) and/or the speed v(t+1) of the device 10 at time (t+1) using measurements and a predictive model based on a specific filter. The predictive model is used to determine the state of the system by successive iterations.

To this end, the measurement module 100 is configured to determine an estimation

$$\hat{x} ( t + 1 ) \qquad [ Math . 1 ]$$

of the state of the system at time t+1 from the estimation

$$\hat{x} ( t ) \qquad [ Math . 2 ]$$

carried out in the previous iteration at time t, a gain K of the filter at time t, a model Φ representative of the system between time t and time t+1 and the innovation

$$ζ ( t + 1 ) \qquad [ Math . 3 ]$$

of the filter at time t+1. The gain K is parameterised by a vector of variable gain coefficients θ1, θ2, etc., θn. A possible gain structure used in the present implementation is given by the equations [Math 36] and following.

The functions of the measurement module 100 for implementing this predictive model will now be described for an iteration performed at time t+1.

The measurement module 100 is configured to calculate the best prediction of the state of the system at time t+1, noted

$$\hat{x} ( t + 1 \vert t ) , \qquad [ Math . 4 ]$$

based on a predetermined estimation of the state of the system at time t, denoted

$$\hat{x} ( t ) , \qquad [ Math . 5 ]$$

and a model Φ of parameters representative of the system.

The measurement module 100 is configured to calculate the prediction of the observation at time t+1, noted

$$\hat{z} ( t + 1 \vert t ) , \qquad [ Math . 6 ]$$

as the product of a predetermined observation matrix H and the best prediction

$$\\ \begin{matrix}\hat{x} ( t + 1 \vert t ) & [ Math . 7 ]\end{matrix}$$

of the state of the system at time t+1 calculated.

Alternatively, H and Φ could be non-linear operators rather than matrices.

The measurement module 100 is configured to calculate the prediction error of the filter, referred to as “innovation”, noted as

$$\\ \begin{matrix}ζ ( t + 1 ) , & [ Math . 8 ]\end{matrix}$$

at time t+1 as the difference between the observation

$$\\ \begin{matrix}z ( t + 1 ) & [ Math . 9 ]\end{matrix}$$

at time t+1 and the prediction

$$\\ \begin{matrix}\hat{z} ( t + 1 \vert t ) & [ Math . 10 ]\end{matrix}$$

of the observation at time t+1.

The measurement module 100 is configured to calculate the estimation of the state of the system at time t+1 as the sum of the best prediction

$$\\ \begin{matrix}\hat{x} ( t + 1 \vert t ) & [ Math . 11 ]\end{matrix}$$

of the state of the system at time t+1 calculated and the product of the gain K at time (t+1) and the filter innovation

$$\\ \begin{matrix}ζ ( t + 1 ) & [ Math . 12 ]\end{matrix}$$

at time t+1 calculated.

The measurement module 100 is configured to determine the vector of gain coefficients θ1, θ2, etc, θn at time (t+1) by minimising the square of the norm of the filter innovation at time (t+1). To this end, the measurement module 100 may be configured to calculate the gradient of the square of the filter innovation

$$\\ \begin{matrix}ζ ( t + 1 ) & [ Math . 13 ]\end{matrix}$$

at time t+1 from the variable gain coefficients θ1, θ2, etc., θn of the gain K.

The measurement module 100 is configured to calculate the gain K at time (t+1), preferably by making a correction by stochastic approximation by time averaging of the gain coefficients θ1, θ2, etc., θn of the vector of gain coefficients determined so as to improve accuracy of the location. In the present example, the stochastic approximation by time averaging comprises determining a vector of gain coefficients θ(t+1) at time (t+1) by minimising the square of the norm of the filter innovation at time (t+1) as described above and updating it by replacing it with the average of the vectors of gain coefficients updated at previous iterations θ(1), θ(2), etc., θ(t).

In the case where the model Φ is linear, this amounts to calculating the gain K(t+1) at time (t+1) for the next iteration by stochastic approximation using time averaging of the gains K(1), etc., K(t) between time 1 and time t.

The measurement module 100 is configured to bound at each iteration the variable gain coefficients θ1, θ2, etc., θn between a minimum and a maximum. Preferably, the minimum is equal to a bounding variable ε and the maximum is equal to (2−ε).

The model Φ is a matrix which describes the transition of the state of the system from time t to time (t+1). Preferably, the model Φ is used to calculate the position and/or the speed, preferably both position and speed, in the state vector x(t+1) but is devoid of an acceleration parameter, which increases the accuracy of the predictions and therefore the location. The acceleration in the model is calculated using the estimated speed. Other parameters may be added (with or without additional sensors). If the model is non-linear, this matrix is obtained by linearisation. It may be calculated once on the first iteration and then retained for the subsequent iterations.

The measurement module 100 is configured to determine the estimation of the state of the system at time (t+1), noted

$$\\ \begin{matrix}\hat{x} ( t + 1 ) , & [ Math . 14 ]\end{matrix}$$

as the sum of the best prediction

$$\\ \begin{matrix}\hat{x} ( t + 1 \vert t ) & [ Math . 15 ]\end{matrix}$$

of the state of the system at time t+1 and the product of the gain K at time t+1 and the innovation

$$\\ \begin{matrix}ζ ( t + 1 ) & [ Math . 16 ]\end{matrix}$$

of the filter at time t+1:

$$\\ \begin{matrix}\hat{x} ( t + 1 ) = \hat{x} ( t + 1 \vert t ) + K ( θ ( t + 1 ) ) ζ ( t + 1 ) & [ Math . 17 ]\end{matrix}$$

The measurement module 100 is configured to determine the position of the device 10 at time (t+1) on the basis of the estimation of the state of the system at time (t+1), notated

$$\\ \begin{matrix}\hat{x} ( t + 1 ) & [ Math . 18 ]\end{matrix}$$

The state of the system x(t+1) is a column vector comprising the position coordinates of the device 10 at time (t+1) and the speed coordinates of the device 10 at time (t+1):

$$\\ \begin{matrix}[ \begin{matrix}p ( t + 1 ) \\ v ( t + 1 )\end{matrix} ] & [ Math . 19 ]\end{matrix}$$

The measurement module 100 is configured to determine the estimation of the position coordinates at time (t+1) by projection of the estimation of the state of the system

$$\\ \begin{matrix}\hat{x} ( t + 1 ) & [ Math . 20 ]\end{matrix}$$

at time (t+1).

In this case, the evolution of the position of the device 10 may be described according to the following equation:

$$\\ \begin{matrix}p ( t + 1 ) = p ( t ) + dt . v ( t ) + \frac{{dt}^{c}}{2} . a ( t ) + w ( t ) & [ Math . 21 ]\end{matrix}$$

Similarly, the evolution of the speed of the device 10 may be described according to the following equation:

$$v ( t + 1 ) = v ( t ) + a ( t ) , dt + {w}^{′} ( t ) \qquad [ Math . 22 ]$$

So there is a matrix Φ such that x(t+1)=Φ, x(t)+A(t)+W(t),

wherein the noise W(t) is the column vector (w(t), w′(t)), and wherein A(t) is a function that depends only on the acceleration. This matrix Φ is the model used in the algorithm and is preferably defined once before or during the first iteration.

The measurement module 100 comprises at least one processor capable of implementing an assembly of instructions allowing these functions to be carried out.

### Example of Implementation

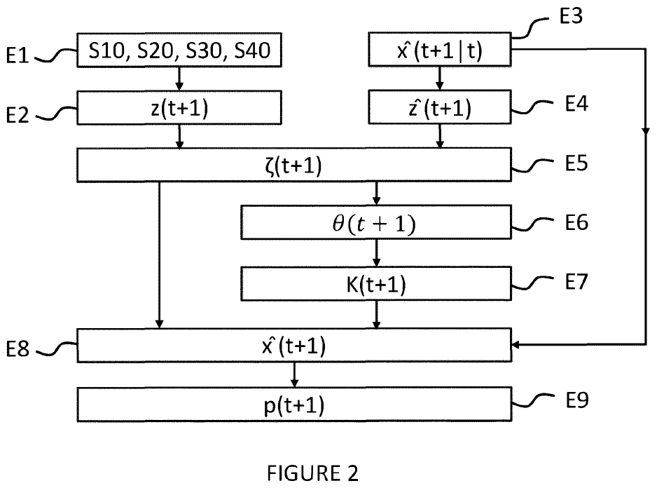

An example of implementation of the method for measuring the position of device 10 will now be described with particular reference to [FIG. 2].

The method is considered to have been previously implemented for t iterations between a time 1 and a time (t). The steps of the method are described below for time (t+1).

In a step E1, the device receives the signals S10, S20, S30, S40 transmitted by the satellites S1, S2, S3, S4 and then, in a step E2, the measurement module 100 determines the position and the speed of the device at time (t+1) from the signals received, referred to as “observation at time (t+1)”, denoted

$$z ( t + 1 ) \qquad [ Math . 23 ]$$

in a way that is inherently familiar.

The measurement module 100 then calculates, in a step E3, the best prediction of the state of the system at time (t+1), denoted

$$\hat{x} ( t + 1 \vert t ) , \qquad [ Math . 24 ]$$

from a predetermined estimation of the state of the system at time (t) (determined at the previous iteration t), denoted

$$\hat{x} ( t ) \qquad [ Math . 25 ]$$

and a model representing the system between time (t) and time (t+1), denoted

$$\hat{x} ( t + 1 \vert t ) = ϕ \hat{x} ( t ) + B \hat{a} ( t ) \qquad [ Math . 26 ]$$

wherein

$$\hat{a} ( t ) \qquad [ Math . 27 ]$$

is the estimation of the acceleration and B is the matrix of coefficients resulting from the limited development of the positions to order 2 and the speed to order 1.

The measurement module 100 then calculates, in a step E4, the prediction

$$\hat{z} ( t + 1 \vert t ) \qquad [ Math . 28 ]$$

of the observation at time t+1 as the product of a predetermined observation matrix H and the best prediction

$$\hat{x} ( t + 1 \vert t ) \qquad [ Math . 29 ]$$

of the state of the system at time t+1 calculated in step E3:

$$\hat{z} ( t + 1 \vert t ) = H \hat{x} ( t + 1 \vert t ) \qquad [ Math . 30 ]$$

The measurement module 100 then calculates, in a step E5, the innovation of the filter at time t+1, noted

$$ζ ( t + 1 ) \qquad [ Math . 31 ]$$

as the difference between the observation at time t+1, denoted

$$z ( t + 1 ) \qquad [ Math . 32 ]$$

calculated in step E2, and the prediction

$$\hat{z} ( t + 1 \vert t ) \qquad [ Math . 33 ]$$

of the observation at time t+1 calculated in step E4:

$$ζ ( t + 1 ) = z ( t + 1 ) - \hat{z} ( t + 1 \vert t ) \qquad [ Math . 34 ]$$

At the current iteration (t+1), the device then calculates, in a step E6, the coefficients

$$θ ( t + 1 ) [ θ 1 , θ 2 , … θ n ] \qquad [ Math . 35 ]$$

of the gain K at time t+1.

To this end, the measurement module 100 minimises the expectation of the square of the norm of the innovation

$$ζ ( t + 1 ) \qquad [ Math . 36 ]$$

of the filter at time t+1 from the equation:

$${θ}^{0} ( t ) = {min}_{\text{?}} ( E {‖ ζ ( t + 1 , θ ) ‖}^{2} ) \qquad [ Math . 37 ]$$

$$\text{?} \text{indicates text missing or illegible when filed}$$

wherein

$$ζ ( t , K ( θ ( t ) ) ) := z ( t ) = H Φ [ \hat{x} ( t - 1 \vert t - 2 ) + K ( θ ( \text{?} ) ) ζ ( t - 1 , K ( {θ}^{\text{?}} ( t - 1 ) ) ) ] \qquad [ Math . 38 ]$$

$$\text{?} \text{indicates text missing or illegible when filed}$$

This equation may, for example, be solved numerically using the known SPSA (Simultaneous Perturbation Stochastic Approximation) method, this known method requiring the calculation of the gradient of the squared norm of the innovation at time (t+1) to determine the minimum.

By solving this equation allows to determine the vector θ(t+1)=(θ1, θ2, etc., θn) which minimises the expectation of the square of the norm of the innovation at time (t+1).

The measurement module 100 then calculates, in a step E7, the gain K(θ(t+1)) at time t+1 preferably from the vector θ calculated in step E6 according to the following formula:

$$K = θ ( t + 1 ) \text{?} {K}_{0} \qquad [ Math . 39 ]$$

$$\text{?} \text{indicates text missing or illegible when filed}$$

wherein

$$\text{?} ( t - 1 ) = diag ( θ 1 , θ 2 , \text{?} θ n ] \qquad [ Math . 40 ]$$

$${K}_{\text{?}} = M \text{?} {{H}^{T} [ H \text{?} M \text{?} {H}^{T} + R ]}^{\text{?}} \qquad [ Math . 41 ]$$

$$\text{?} \text{indicates text missing or illegible when filed}$$

wherein

$$M = Φ \text{?} {P}_{0} \text{?} {Φ}^{T} + Q \qquad [ Math . 42 ]$$

$$\text{?} \text{indicates text missing or illegible when filed}$$

Pₒ may be the initial covariance matrix used in a known way in a Kalman filter of the prior art,
Q is an arbitrary positive semi-definite symmetric matrix, but preferably chosen close to the covariance matrix of the model noise, i.e. the noise W(t) in the equation x(t+1)=Φ·x(t)+W(t) described above.

The device then calculates, in a step E8, the estimation of the state of the system at time (t+1), denoted

$$\hat{x} ( t + 1 ) , \qquad [ Math . 43 ]$$

as the sum of the best prediction

$$\hat{x} ( t + 1 \vert t ) \qquad [ Math . 44 ]$$

of the state of the system at time t+1 calculated in step E3, and of the product of the gain K at time t+1 (calculated in step E7) by the innovation

$$ζ ( t + 1 ) \qquad [ Math . 45 ]$$

of the filter at time t+1 (calculated in step E5:

$$\hat{x} ( t + 1 ) = \hat{x} ( t + 1 \vert t ) = K ( θ ( t + 1 ) ) ζ ( t + 1 ) \qquad [ Math . 46 ]$$

This estimation

$$\hat{x} ( t + 1 ) \qquad [ Math . 47 ]$$

of the state of the system at time t+1 will then be used in step E3 of the next iteration at time t+2.

The position p(t+1) of the device 10 is determined at time (t+1) in a step E9.

The state of the system x(t+1) is a column vector comprising the coordinates of position of the device 10 at time (t+1) and the speed coordinates of the device 10 at time (t+1):

$$[ \begin{matrix}p ( t + 1 ) \\ v ( t + 1 )\end{matrix} ] \qquad [ Math . 48 ]$$

The estimation of the position coordinates at time (t+1) is obtained by projection of the estimation of the state of the system

$$\hat{x} ( t + 1 ) \qquad [ Math . 49 ]$$

at time (t+1).

Thus, the evolution of the position of the device 10 is described according to the following equation:

$$p ( t + 1 ) = p ( t ) + dt \text{?} v ( t ) + \frac{d \text{?}}{2} \text{?} a ( t ) + w ( t ) \qquad [ Math . 50 ]$$

$$\text{?} \text{indicates text missing or illegible when filed}$$

Similarly, the evolution of the speed of the device 10 is described according to the following equation:

$$v ( t + 1 ) = v ( t ) + a ( t ) \text{?} dt + {w}^{\text{?}} ( t ) \qquad [ Math . 51 ]$$

$$\text{?} \text{indicates text missing or illegible when filed}$$

There therefore exists a matrix Φ such that x(t+1)=Φ·x(t)+A(t)+W(t): wherein the noise W(t) is the column vector (w(t), w′(t), and wherein A(t) is a function which depends only on the acceleration. This matrix Φ is the previously described model used in the algorithm and is preferably defined once before or during the first iteration.

In one embodiment, the calculations, in particular of the gain coefficients, may be carried out by a neural network on the basis of a predetermined sample. In this case, the parameters of the cost function to be minimised are the weights W of the neural network which minimises the difference between the training data and the outputs of said neural network.

This arrangement may be seen as a generalisation of the device described above. In its simplest version, a single hidden layer of neurons is sufficient, with linear activation functions. Advantageously, it is not the matrix of gain K that is replaced by a neural network, but the matrix Kₒ (defined in 0170). The filter structure is then:

$$\hat{x} ( t + 1 ) = \hat{x} ( t + 1 \vert t ) + θ \cdot NN ( ζ ( t + 1 ) ) \qquad [ Math . 52 ]$$

wherein θ is the previously defined parameter matrix, chosen as before to minimise the innovation, and NN is the neural network.

### Examples of Simulations

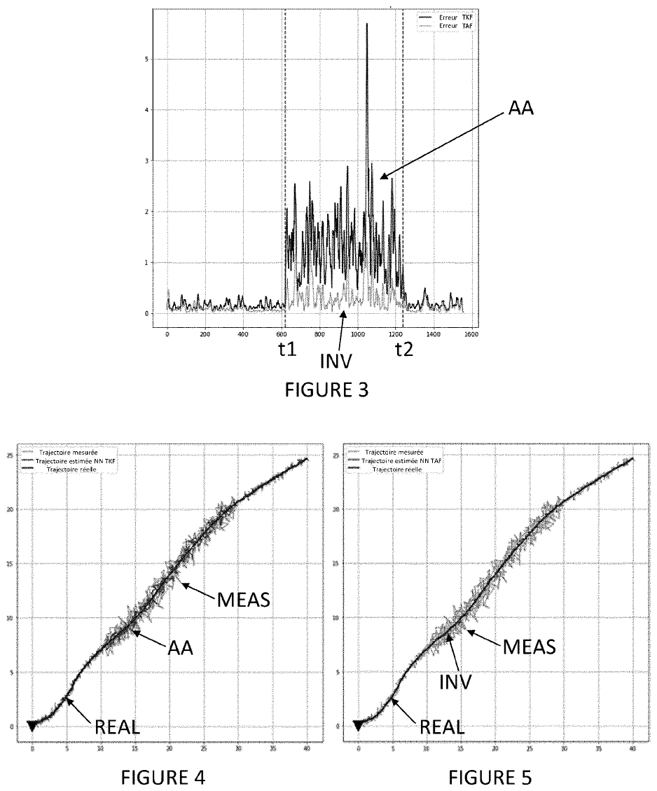

It is shown in [FIG. 3] an example of a comparison of the squared error between the actual trajectory and the estimated trajectory (i.e. the squared norm of the difference between the actual trajectory and the estimated trajectory at each time) with a prior art method based on a Kalman filter (upper curve AA, captioned “Error NN TKF”) and with the method according to the invention (lower curve INV, captioned “Error NN TAF”) for a mobile device 10 passing under a bridge between two times t1 and t2.

The x-axis represents the number of iterations of the method. The y-axis represents the squared error (in metres), i.e. the square of the difference between the estimated trajectory and the reference trajectory.

It may be seen that the prior art method based on a Kalman filter generates an error of more than five metres, whereas the method according to the invention generates an error not exceeding 0.3 metres.

[FIG. 4] illustrates an example showing the error obtained on a given trajectory with a prior art Kalman filter.

The x-axis represents a distance (in metres) in a first direction. The y-axis represents a distance (in metres) in a second direction. The black line represents the real trajectory REAL followed by the mobile device 10 (assembly of the real positions). The light line represents the positions measured without MEAS filtering. The intermediate grey line represents the positions measured with a Kalman filtering of the prior art AA.

[FIG. 5] shows an example showing the error obtained on the same trajectory with a filter according to the invention.

The x-axis represents a distance (in metres) in a first direction. The y-axis represents a distance (in metres) in a second direction. The black line represents the real trajectory REAL followed by the mobile device 10 (assembly of the real positions). The light line represents the positions measured without MEAS filtering. The intermediate grey line represents the positions measured with a filtering according to the invention INV.

It may be seen that the positions determined with the filter according to the invention are significantly closer to the real trajectory than those determined with a Kalman filter of the prior art.

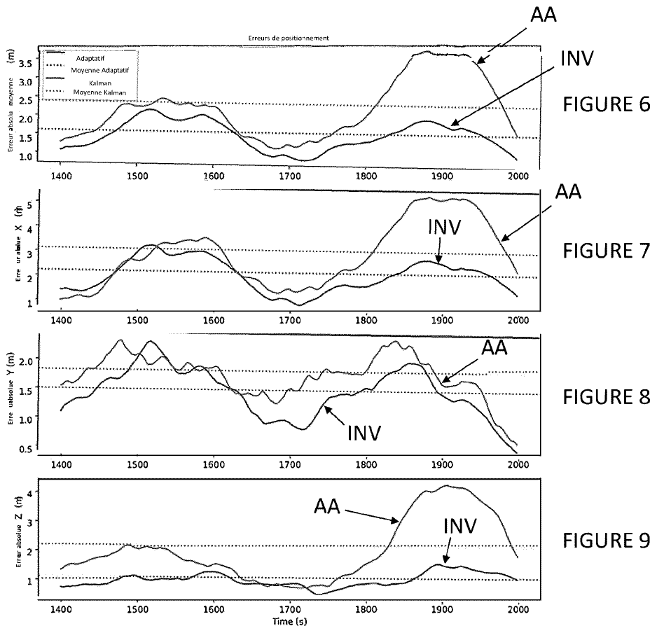

FIGS. 6 to 9 illustrate a further comparison between a Kalman filter of the prior art and a method according to the invention for a trajectory of a mobile of the vehicle type. It may be seen that the absolute error along the three dimensional axes X, Y and Z is always lower on average with the method according to the invention than with a solution based on a Kalman filter, and that the average absolute error is approximately 50% lower on average with the method according to the invention compared with a solution based on a Kalman filter.

1-10. (canceled)

11. A method for measuring a geographical position of a device based on a network of satellites in a predictive system with a filter of variable gain, said gain being represented by a vector of variable gain coefficients, said method, implemented by the device, comprising at each iteration following a time t the steps of:
receiving signals transmitted by a plurality of satellites in the satellite network,
determining the position and/or the speed of the device at a time from the signals received, referred to as “observation at time”,
calculating the best prediction of the state of the system at time on the basis of a predetermined estimation of the state of the system at time and a model representing the system between time and time,
calculating the prediction of the observation at time as the product of a predetermined observation matrix and the best prediction of the state of the system at time calculated,
calculating the innovation of the filter at time as the difference between the observation at time and the prediction of the observation at time,
determining the vector of gain coefficients at time by minimizing the square of the norm of the innovation of the filter at time calculated in the previous step,
calculating the gain at time by making a correction by stochastic approximation using time averaging of the gain coefficients of the vector of gain coefficients determined,
calculating the estimation of the state of the system at time as being the sum of the best prediction of the state of the system at time calculated and the product of the gain at time by the innovation of the filter at time calculated,
determining the position of the device from the estimation of the state of the system at time calculated.

12. The method as claimed in claim 11, further comprising, at each iteration, a step of bounding the variable gain coefficients between a minimum and a maximum.

13. The method according to claim 12, wherein the minimum is equal to a bounding variable ε and the maximum is equal to (2−ε).

14. The method according to claim 11, wherein the calculations are carried out by a neural network on the basis of a predetermined sample.

15. The method according to claim 11, wherein the model describing the transition from the state of the system at time t to the state at time is devoid of acceleration.

16. A computer program product comprising an assembly of program code instructions which, when executed by one or more processors, is configured to cause the processor or processors to implement a method according to claim 1.

17. A measurement module for measuring the geographical position of a device based on a network of satellites in a predictive system with a filter of variable gain, said gain being represented by a vector of variable parameters, said measurement module, embedded in said device, being configured for:
receiving signals transmitted by a plurality of satellites in the satellite network,
determining the position and/or the speed of the device at a time from the signals received, referred to as “observation at time”,
calculating the best prediction of the state of the system at time on the basis of a predetermined estimation of the state of the system at time and a model representing the system between time and time,
calculating the prediction of the observation at time as the product of a predetermined observation matrix and the best prediction of the state of the system at time calculated,
calculating the filter innovation at time as the difference between the observation at time and the prediction of the observation at time,
determining the vector of gain coefficients at time by minimising the square of the norm of the filter innovation at time,
calculating the gain at time by correcting by stochastic approximation using time averaging of the gain coefficients of the vector of gain coefficients determined,
calculating the estimation of the state of the system at time as the sum of the best prediction of the state of the system at time calculated and the product of the gain at time by the filter innovation at time calculated,
determining the position of the device from the estimation of the state of the system at time calculated.

18. The measurement module according to claim 1, said module being configured to bound the variable gain coefficients between a minimum and a maximum.

19. A device, comprising a measurement module according to claim 7.

20. A satellite-based geolocation system, said system comprising a plurality of satellites, each configured to transmit geolocation signals, and at least one measurement module according to claim 17 and at least one device comprising the measurement module.

21. A satellite-based geolocation system, said system comprising a plurality of satellites, each configured to transmit geolocation signals, and at least one device comprising the measurement module of claim 19.
